(19) United States
(12) Patent Application Publication
(10) Pub. No.: US 2020/0031132 A1
(43) Pub. Date: Jan. 30, 2020

(54) LIQUID CARTRIDGE INCLUDING SEALING MEMBER FITTED IN CAP COVERING LIQUID SUPPLY TUBE

(71) Applicant: BROTHER KOGYO KABUSHIKI KAISHA, Nagoya-shi (JP)

(72) Inventors: Akihito ONO, Nagoya-shi (JP); Masahiro HAYASHI, Nagoya-shi (JP); Naoya OKAZAKI, Gifu-ken (JP); Toshio SUGIURA, Anjo-shi (JP); Yuji KOGA, Nagoya-shi (JP)

(73) Assignee: BROTHER KOGYO KABUSHIKI KAISHA, Nagoya-shi (JP)

(21) Appl. No.: 16/522,128

(22) Filed: Jul. 25, 2019

(30) Foreign Application Priority Data
Jul. 30, 2018 (JP) 2018-142567

(51) Int. Cl. B41J 2/175

(52) U.S. Cl. CPC B41J 2/17523; B41J 2/1754

(57) ABSTRACT

A liquid cartridge includes a liquid supply tube, a sealing member, and a cap. The sealing member seals an opening of the liquid supply tube. The sealing member includes a cylindrical portion, a first protrusion, a second protrusion, and a third protrusion. The first protrusion protrudes radially inward. The first protrusion has a first protruding end defining a first sealing surface facing an axis of the cylindrical portion. The second protrusion protrudes radially outward to have a second protruding end in a direction away from the axis. The second protrusion has a second sealing surface in contact with the liquid supply tube. The third protrusion protrudes along the axis to have a third protruding end. The third protrusion has a contacting surface inclined relative to the axis to face the axis. The contacting surface is in contact with the cap.

### CROSS REFERENCE TO RELATED APPLICATION

This application claims priority from Japanese Patent Application No. 2018-142567 filed Jul. 30, 2018. The entire content of the priority application is incorporated herein by reference.

### TECHNICAL FIELD

The present disclosure relates to a liquid cartridge including a seal member and a cap assembled to a liquid supplying cylinder for discharging liquid stored in a liquid storage chamber. The present disclosure further relates to a liquid supplying device including the ink cartridge and a cartridge attachment section to which the ink cartridge is detachably attachable.

### BACKGROUND

A printer provided with a recording head for ejecting ink supplied from an ink cartridge through nozzles is known in the art. The printer includes an ink needle connected to the recording head and though which the ink is supplied. The ink cartridge is attachable to and detachable from the printer. The ink cartridge has an ink supply hole for supplying the ink to the recording head through the ink needle. The ink cartridge includes a sealing member fitted to the ink supply hole. The sealing member prevents the ink from leaking out of the ink supply hole in a state where the ink cartridge is connected to the ink needle. Further, the ink cartridge includes a cap attached to the ink supply hole to fix the sealing member (for example, U.S. Pat. No. 5,425,478).

### SUMMARY

When the ink cartridge is attached to the printer, the ink needle is inserted into a through hole formed in the sealing member. At this time, the sealing member may be pulled in an insertion direction of the ink needle by friction generated between an outer peripheral surface of the ink needle and the sealing member. The sealing member may be therefore detached from the cap, which may weaken sealability provided by the sealing member. As a result, ink may leak through the ink supply hole.

In view of foregoing, it is an object of the disclosure to provide a liquid cartridge capable of restricting disassembly between a sealing member and a cap, and a liquid supplying device using the same.

In order to attain the above and other objects, according to one aspect, the present disclosure provides a liquid cartridge detachably attachable to an attachment section including a liquid supply needle. The liquid cartridge includes a housing, a liquid supply tube, a sealing member, and a cap. The housing has a liquid storage chamber configured to store liquid therein. The liquid supply tube defines an internal space therein and extends in an extending direction from the housing and has a distal end formed with an opening. The liquid supply tube is configured to provide communication between the liquid storage chamber and the liquid supply needle. The sealing member seals the opening of the liquid supply tube and has a liquid supply hole extending in the extending direction. The cap has an opening through which the liquid supply needle is inserted. The sealing member is interposed between the cap and the liquid supply tube in the extending direction. The sealing member is elastically deformable. The sealing member includes a cylindrical portion, a first protrusion, a second protrusion, and a third protrusion. The cylindrical portion defines an axis extending in the extending direction. The first protrusion protrudes radially inward from an inner peripheral surface of the cylindrical portion. The first protrusion has a first protruding end defining a first sealing surface facing the axis. The first sealing surface is configured to contact an outer peripheral surface of the liquid supply needle. The second protrusion protrudes radially outward from an outer peripheral surface of the cylindrical portion to have a second protruding end in a direction away from the axis. The second protruding end has a second sealing surface in contact with the distal end of the liquid supply tube. The third protrusion protrudes from the cylindrical portion in the extending direction along the axis to have a third protruding end in the extending direction. The third protrusion has a contacting surface inclined relative to the axis to face the axis. The contacting surface is in contact with the cap.

According to another aspect, the present disclosure also provides a liquid supplying device including the above liquid cartridge, and a cartridge attachment section. The liquid cartridge is detachably attachable to the cartridge attachment section. The cartridge attachment section includes a liquid supply needle, and a needle valve. The liquid supply needle defines an inner space therein and has a distal end formed with an opening. The needle valve is positioned in the inner space of the liquid supply needle. The needle valve is configured to open and close the opening of the liquid supply needle. In a state where the liquid cartridge is attached to the cartridge attachment section, the liquid supply needle is inserted in the liquid supply tube through the liquid supply hole and the opening of the cap. The needle valve contacts the valve to open the opening of the liquid supply needle to provide communication between the inner space of the liquid supply needle and the liquid storage chamber.

According to still another aspect, the present disclosure also provides a liquid cartridge includes a housing, a liquid supply tube, a sealing member, and a cap. The housing has a liquid storage chamber configured to store liquid therein. The liquid supply tube defines an internal space therein and extends in an extending direction from the housing and has a distal end formed with an opening. The sealing member seals the opening of the liquid supply tube and has a liquid supply hole extending in the extending direction. The cap has an opening. The sealing member is interposed between the cap and the liquid supply tube in the extending direction. The sealing member is elastically deformable. The sealing member includes a cylindrical portion, a first protrusion, a second protrusion, and a third protrusion. The cylindrical portion defines an axis extending in the extending direction. The first protrusion protrudes radially inward from an inner peripheral surface of the cylindrical portion. The first protrusion has a first protruding end defining a first sealing surface facing the axis. The second protrusion protrudes radially outward from an outer peripheral surface of the cylindrical portion to have a second protruding end in a direction away from the axis. The second protruding end has a second sealing surface in contact with the distal end of the liquid supply tube. The third protrusion protrudes from the cylindrical portion in the extending direction along the axis to have a third protruding end in the extending direction. The third protrusion has a contacting surface inclined relative to the axis to face the axis. The contacting surface is in contact with the cap.

### BRIEF DESCRIPTION OF THE DRAWINGS

The particular features and advantages of the embodiment as well as other objects will become apparent from the following description taken in connection with the accompanying drawings, in which:

FIG. 1 is a schematic vertical cross-sectional diagram illustrating an internal structure of a printer provided with a cartridge attachment section to which an ink cartridge according to one embodiment is detachably attachable;

FIG. 2 is a cross-sectional view of the cartridge attachment section according to the embodiment as viewed from a rear side thereof;

FIG. 3 is a vertical cross-sectional view of the cartridge attachment section and the ink cartridge according to the embodiment, illustrating a state where the ink cartridge is attached to the cartridge attachment section;

FIG. 4 is a perspective view of the ink cartridge according to the embodiment as viewed from a rear side thereof;

FIG. 5 is an exploded perspective view of the ink cartridge according to the embodiment, illustrating a state where a sealing member, a valve, a coil spring and a cap are disassembled;

FIG. 6 is a perspective view of the cap, illustrating a vertical cross-section of the cap;

FIG. 7 is a vertical cross-sectional view of the sealing member as viewed from a left side thereof;

FIG. 8 is a partially enlarged vertical cross-sectional view illustrating an ink supply portion and in the vicinity thereof before an ink needle of the cartridge attachment section is inserted into the ink supply portion; and

FIG. 9 is a partially enlarged vertical cross-sectional view illustrating the ink supply portion and in the vicinity thereof in a state where the ink needle is inserted into the ink supply portion.

### DETAILED DESCRIPTION

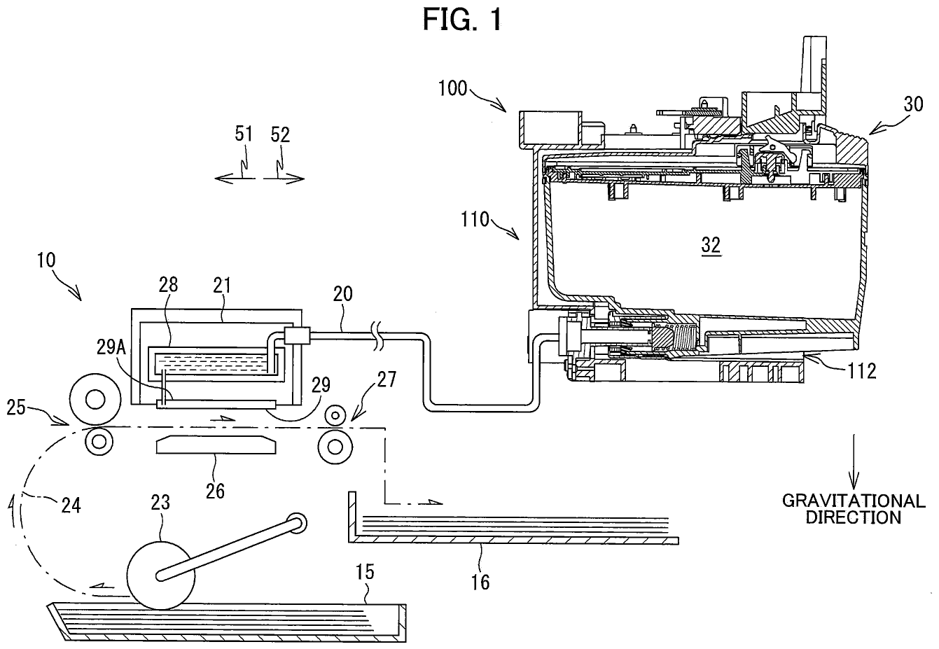

An ink cartridge 30 according to one embodiment and a printer 10 to which the ink cartridge 30 is detachably attachable will be described with reference to FIGS. 1 through 9, wherein like parts and components are designated by the same reference numerals to avoid duplicating description.

In the following description, a direction in which the ink cartridge 30 is inserted into a cartridge attachment section 110 of the printer 10 is defined as a “frontward direction 51,” while a direction in which the ink cartridge 30 is removed from the cartridge attachment section 110 is defined as a “rearward direction 52.” The frontward direction 51 and the rearward direction 52 are opposite to each other. As will be described later, the ink cartridge 30 is inserted into and removed from the cartridge attachment section 110 in a horizontal direction. Both the frontward direction 51 and the rearward direction 52 are therefore regarded as directions parallel to a horizontal plane perpendicular to the gravitational direction. However, the frontward direction 51 and the rearward direction 52 do not have to coincide with the horizontal direction. Further, a direction perpendicular to the frontward direction 51 or the rearward direction 52 is defined as a “downward direction 53.” A direction opposite to the downward direction 53 is defined as an “upward direction 54.” A direction perpendicular to the frontward direction 51 and the downward direction 53 is defined as a “rightward direction 55.” A direction opposite to the rightward direction 55 is defined as a “leftward direction 56.” The rightward direction 55 and the leftward direction 56 are also parallel to the horizontal plane.

Hence, in a state where the ink cartridge 30 is attached to the cartridge attachment section 110, that is, in a state where the ink cartridge 30 is capable of being used or operated by the printer 10, the downward direction 53 is coincident with a direction of a gravitational force acting on the ink cartridge 30 (i.e. gravitational direction), and the upward direction 54 is coincident with a direction opposite to the gravitational direction.

Further, as described above, the rightward direction 55 and the leftward direction 56 are defined as directions perpendicular to the frontward direction 51 and the downward direction 53. More specifically, in the state where the ink cartridge 30 is attached to the cartridge attachment section 110 and is capable of being used by the printer 10, the rightward direction 55 is a direction toward the right and the leftward direction 56 is a direction toward the left when the ink cartridge 30 is viewed from a rear side thereof.

Note that a state where the ink cartridge 30 is attached to the cartridge attachment section 110 or a state where the ink cartridge 30 is capable of being operated by the printer 10 implies a state of the ink cartridge 30 that has been completely inserted into an attachment position in the cartridge attachment section 110. At the attachment position, an ink needle 102 (described later) provided at the cartridge attachment section 110 is inserted into an ink supply portion 34 (described later) of the ink cartridge 30 to be connected to the ink supply portion 34. Hereinafter, a posture of the ink cartridge 30 in a state where the ink cartridge 30 is attached to the cartridge attachment section 110 or a state where the ink cartridge 30 is capable of being operated by the printer 10 will be referred to as an “operational posture.”

Further, the frontward direction 51 and the rearward direction 52 may be collectively referred to as a “front-rear direction.” The upward direction 54 and the downward direction 53 may be collectively referred to as an “up-down direction.” The rightward direction 55 and the leftward direction 56 may be collectively referred to as a “left-right direction.”

Further, in the following description, an expression “facing frontward” means “facing in a direction containing a frontward component,” and an expression “facing rearward” means “facing in a direction containing a rearward component.” Further, an expression “facing downward” means “facing in a direction containing a downward component,” and an expression “facing upward” means “facing in a direction containing an upward component.” For example, a phrase “A front surface faces frontward.” denotes that the front surface may face in the frontward direction, or the front surface may face in a direction inclined relative to the frontward direction as long as the direction contains a frontward component.

<Overview of Printer 10>

As illustrated in FIG. 1, the printer 10 is an image recording apparatus configured to selectively eject ink droplets onto recording sheets to record images thereon based on an inkjet recording system. The printer 10 is, for example, an inkjet printer. The printer 10 includes a recording head 21, an ink supplying device 100, and a plurality of ink tubes 20 each connecting the recording head 21 to the ink supplying device 100. The ink supplying device 100 includes the cartridge attachment section 110. The cartridge attachment section 110 can detachably accommodate a plurality of ink cartridges 30. The cartridge attachment section 110 has one end formed with an opening 112. Through the opening 112, each of the ink cartridges 30 can be inserted into the cartridge attachment section 110 in the frontward direction 51 and removed from the cartridge attachment section 110 in the rearward direction 52.

Each of the ink cartridges 30 stores liquid therein. Specifically, each ink cartridge 30 stores ink therein that can be used for printing operations performed in the printer 10. When the ink cartridges 30 has been completely attached to the cartridge attachment section 110, the ink cartridges 30 are connected to the recording head 21 through the corresponding ink tubes 20. The recording head 21 includes a plurality of (four in the embodiment) damper chambers 28 corresponding to the plurality of ink cartridges 30. Each damper chamber 28 is adapted to temporarily store the ink supplied from the corresponding ink cartridge 30 through the corresponding ink tube 20. The recording head 21 also includes a plurality of nozzles 29 through which the ink supplied from the respective damper chambers 28 is selectively ejected. More specifically, the recording head 21 is provided with a head control board (not illustrated), and a plurality of piezoelectric elements 29A corresponding one-on-one to the plurality of nozzles 29. The head control board is configured to selectively apply drive voltages to the plurality of piezoelectric elements 29A to eject ink selectively from the nozzles 29. In this way, the recording head 21 is configured to consume ink stored in each ink cartridge 30 in a state where the ink cartridge 30 is attached to the cartridge attachment section 110.

The printer 10 includes a sheet feeding tray 15, a sheet feeding roller 23, a pair of conveying rollers 25, a platen 26, a pair of discharge rollers 27, and a sheet discharge tray 16. The sheet feeding roller 23 is configured to feed recording sheets from the sheet feeding tray 15 onto a conveying path 24. The recording sheets conveyed to the conveying path 24 are then received by the pair of conveying rollers 25. The pair of conveying rollers 25 conveys the recording sheets to a position between the recording head 21 and the platen 26. The recording head 21 selectively ejects ink onto the recording sheets as the recording sheets passes over the platen 26, whereby images are recorded on the recording sheets. The pair of discharge rollers 27 receives the recording sheets that have passed over the platen 26 and discharges the recording sheets onto the sheet discharge tray 16 provided at a position most downstream in the conveying path 24.

<Ink Supplying Device 100>

As illustrated in FIG. 1, the ink supplying device 100 is provided in the printer 10. The ink supplying device 100 is configured to supply ink to the recording head 21. The ink supplying device 100 includes the cartridge attachment section 110 and the plurality of (four in the embodiment) ink tubes 20. The ink cartridges 30 are detachably attachable to the cartridge attachment section 110. Note that FIG. 1 illustrates a state where one of the ink cartridges 30 has been completely attached to the cartridge attachment section 110. That is, in FIG. 1, the ink cartridge 30 is in an attached state where the ink cartridge 30 has been completely attached to the cartridge attachment section 110. In other words, the ink cartridge 30 illustrated in FIG. 1 is in its operational posture described above. The ink supplying device 100 and the ink cartridge 30 constitute an example of the system.

<Cartridge Attachment Section 110>

As illustrated in FIGS. 1 to 3, the cartridge attachment section 110 includes a case 101 and the plurality of (four in the embodiment) ink needles 102. In the embodiment, four ink cartridges 30 corresponding to respective four colors of cyan, magenta, yellow, and black can be accommodated in the cartridge attachment section 110. The four ink needles 102 are provided in one-to-one correspondence with the four ink cartridges 30. For an explanatory purpose, in the following description and the drawings, only one ink cartridge 30 is assumed to be attached to the cartridge attachment section 110 unless otherwise specified.

<Case 101>

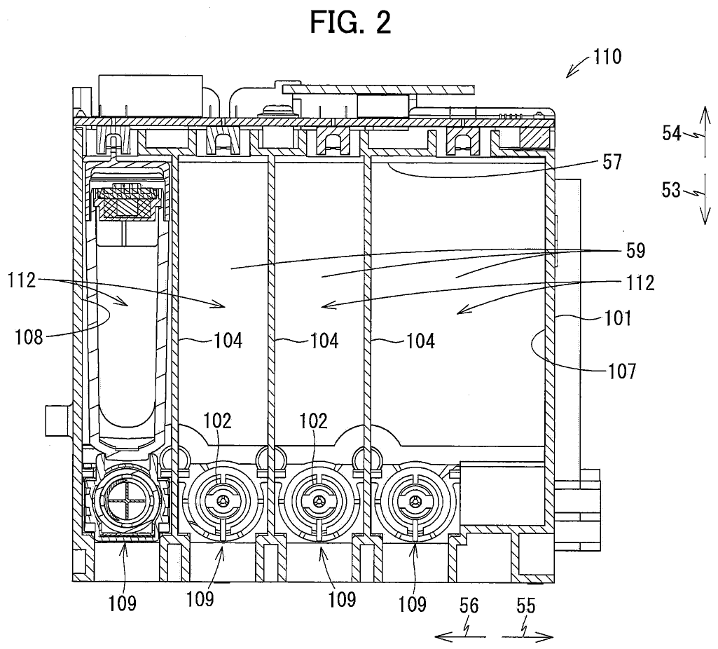

As illustrated in FIG. 2, the case 101 constitutes a housing of the cartridge attachment section 110. The case has a generally box-like shape defining an internal space. The case 101 has an inner top surface 57, an inner bottom surface, an inner right-side surface 107, an inner left-side surface 108, an inner end surface 59, and the opening 112. The inner top surface 57 defines a ceiling of the internal space of the case 101. The inner bottom surface defines a bottom of the internal space of the case 101. The inner right-side surface 107 defines a right edge of the internal space of the case 101. The inner left-side surface 108 defines a left edge of the internal space of the case 101. The inner end surface 59 connects the inner top surface 57, the inner bottom surface, the inner right-side surface 107, and the inner left-side surface 108. The opening 112 is formed in the case 101 at a position facing the inner end surface 59 in the front-rear direction. The opening 112 can be exposed to a user-interface surface of the printer 10 that a user faces when operating the printer 10.

Each ink cartridge 30 can be inserted into and removed from the case 101 through the opening 112. The case 101 has a bottom end portion formed with a plurality of (four in the embodiment) guide grooves 109 for guiding insertion and removal of the ink cartridges 30 relative to the case 101. Movements of the respective ink cartridges 30 in the front-rear direction (i.e., in FIG. 2, a direction perpendicular to a sheet surface) are guided by the corresponding guide grooves 109 as lower end portions of the ink cartridges 30 are inserted into the corresponding guide grooves 109. The case 101 includes three plates 104 (FIG. 2) that partition the internal space into four individual spaces each elongated in the up-down direction. Each of the four spaces partitioned by the plates 104 can receive corresponding one of the four ink cartridges 30.

<Ink Needle 102>

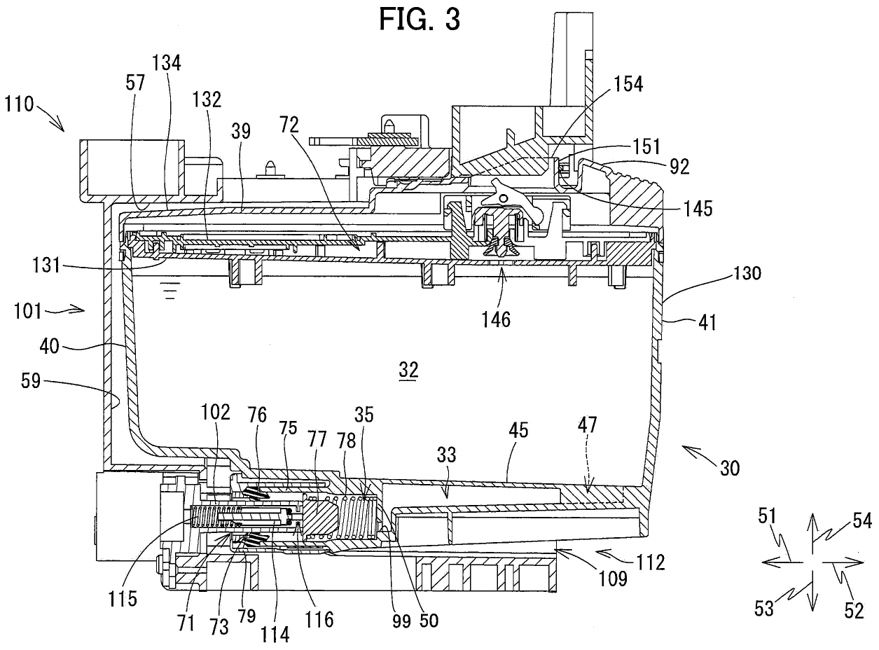

As illustrated in FIGS. 2 and 3, each ink needle 102 has a hollow tubular shape and is disposed at a lower end portion of an end wall (i.e. a wall having the inner end surface 59) of the case 101. The ink needles 102 are arranged below the inner end surface 59 at positions each corresponding to the ink supply portion 34 of the corresponding ink cartridge 30 accommodated in the cartridge attachment section 110. Each ink needle 102 protrudes rearward from the lower end portion of the end wall of the case 101. Each ink needle 102 has a distal end formed with an opening 116.

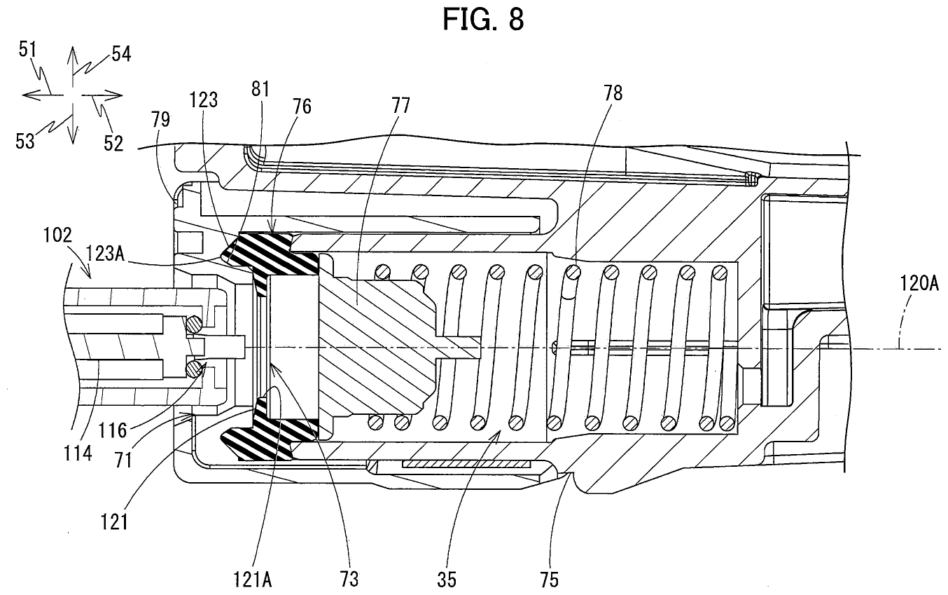

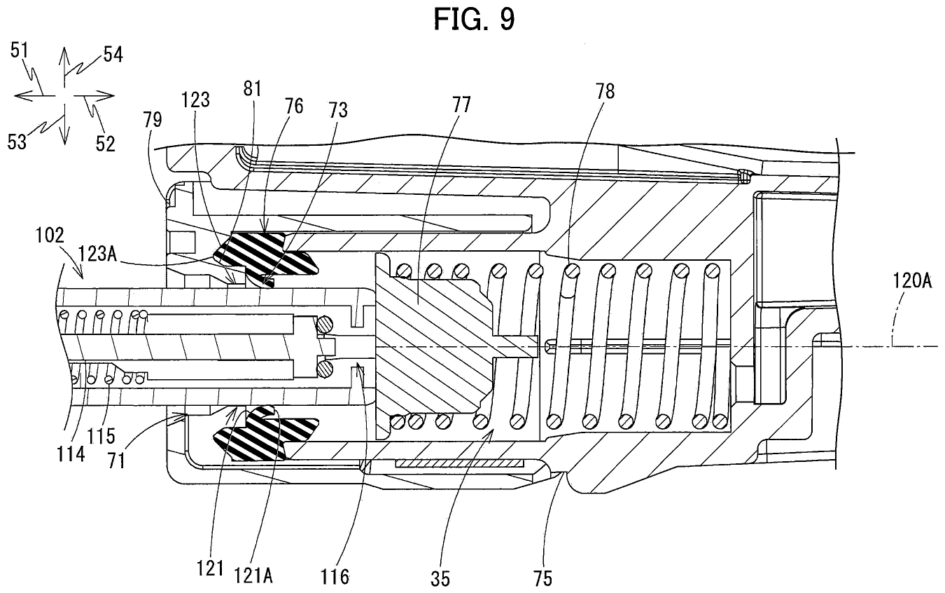

Each ink needle 102 defines an internal space in which a valve 114 and a coil spring 115 are accommodated. Within the internal space, the valve 114 is movable in the frontward direction 51 and the rearward direction 52 between a closed position and an open position. In the closed position (see FIG. 8), the valve 114 closes the opening 116, while in the open position (see FIG. 9), the valve 114 opens the opening 116. The coil spring 115 urges the valve 114 in a direction toward the closed position, that is, rearward direction 52 to close the opening 116. In the closed position, a front end of the valve 114 protrudes further rearward relative to the opening 116.

<Lock Shaft 145>

As illustrated in FIG. 3, the case 101 is provided with a lock shaft 145. The lock shaft 145 extends in the left-right direction (a width direction of the casing 101) and is disposed in the vicinity of the inner top surface 57 and the opening 112 of the case 101. The lock shaft 145 is a rod-like member extending in the left-right direction. The lock shaft 145 is formed of metal and has a columnar shape, for example. The lock shaft 145 has left and right end portions fixed to walls defining left and right ends of the case 101. Hence, the lock shaft 145 is immovable, for example, not pivotable, relative to the case 101. The lock shaft 145 extends in the left-right direction to span the four spaces of the case 101 each for accommodating the corresponding one of the ink cartridges 30. In each of these cartridge-accommodating spaces, a space exists around the lock shaft 145. A lock surface 151 (described later) of each ink cartridge 30 can therefore access the lock shaft 145 by moving upward or rearward.

The lock shaft 145 is adapted to retain the ink cartridge 30 attached to the cartridge attachment section 110 at the attachment position. The ink cartridge 30 is brought into engagement with the lock shaft 145 when the ink cartridge 30 is inserted into the cartridge attachment section 110 and then pivotally moved upward to the operational posture. Further, the lock shaft 145 retains the ink cartridge 30 at the attachment position in the cartridge attachment section 110 against an urging force of a coil spring 78 of the ink cartridge 30 that pushes the ink cartridge 30 rearward in the state where the ink cartridge 30 is attached to the cartridge attachment section 110.

<Overall Structure of Ink Cartridge 30>

The ink cartridge 30 is a container for storing liquid, such as ink, therein. As described above, in the embodiment, four of the ink cartridges 30 corresponding to respective four colors of cyan, magenta, yellow, and black can be attached to the cartridge attachment section 110. Of the four ink cartridges 30, three ink cartridges 30 respectively corresponding to three colors of cyan, magenta, and yellow are identical in structure. On the other hand, the ink cartridge 30 corresponding to the color of black differs in structure from the other three ink cartridge 30 in that the ink cartridge 30 corresponding to the color of black has a dimension in the left-right direction (width direction) that is greater than that of each of the remaining three ink cartridges 30 corresponding to colors of cyan, magenta, and yellow. Other than this difference, the ink cartridge 30 corresponding to the color of black is substantially identical to the other three ink cartridges 30 corresponding to colors of cyan, magenta, and yellow.

Next will be described the structure of the ink cartridge 30 corresponding to each of the colors of cyan, magenta, and yellow in detail.

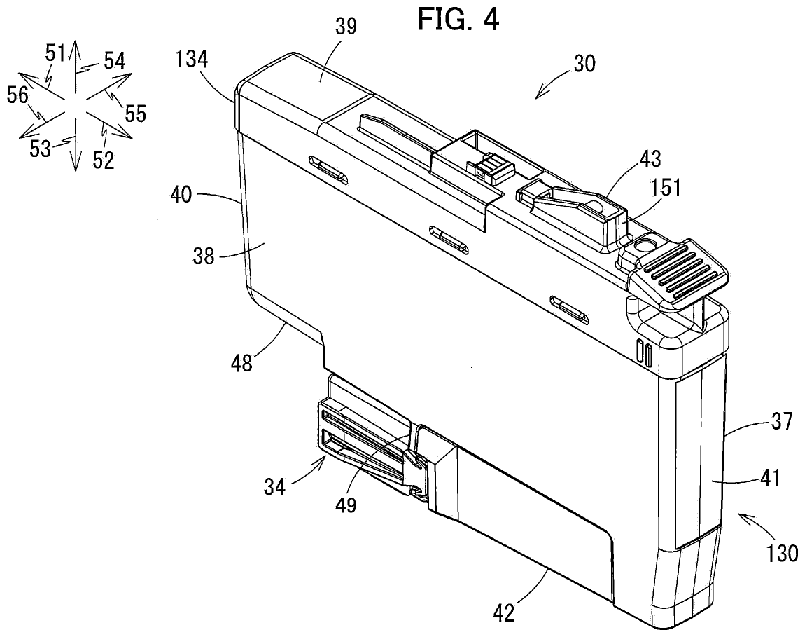

The posture of the ink cartridge 30 illustrated in FIG. 4 is a posture of the ink cartridge 30 in the operational posture, that is, a posture of the ink cartridge 30 in a state where the ink cartridge 30 is capable of being used in the printer 10. The ink cartridge 30 includes a front wall 40, a rear wall 41, a top wall 39, bottom wall, a right side wall 37, and a left side wall 38.

In the operational posture of the ink cartridge 30, the front wall 40 faces frontward and the rear wall 41 faces rearward. In the operational posture of the ink cartridge 30, the top wall 39 faces upward. Further, in the operational posture of the ink cartridge 30, a front end of the top wall 39 is connected to an upper end of the front wall 40 and a rear end of the top wall 39 is connected to an upper end of the rear wall 41.

In the operational posture of the ink cartridge 30, the bottom wall face downward. Further, in the operational posture of the ink cartridge 30, a front end of the bottom wall is connected to a lower end of the front wall 40 and a rear end of the bottom wall is connected to a lower end of the rear wall 41. In the embodiment, the bottom wall includes a main bottom wall 42, a subordinate bottom wall 48, and a connecting wall 49. The connecting wall 49 connects the main bottom wall 42 to the subordinate bottom wall 48. The main bottom wall 42 connects the lower end of the rear wall 41 to a lower end of the connecting wall 49. The subordinate bottom wall 48 connects the lower end of the front wall 40 to an upper end of the connecting wall 49.

When the ink cartridge 30 is in the operational posture, a direction from the rear wall 41 toward the front wall 40 coincides with the frontward direction 51, and a direction from the front wall 40 toward the rear wall 41 coincides with the rearward direction 52. Further, when the ink cartridge 30 is in the operational posture, a direction from the top wall 39 toward the bottom wall coincides with the downward direction 53 (i.e., the gravitational direction), and a direction from the bottom wall toward the top wall 39 coincides with the upward direction 54. Still further, when the ink cartridge 30 is in the operational posture, a direction from the left side wall 38 toward the right side wall 37 coincides with the rightward direction 55, and a direction from the right side wall 37 toward the left side wall 38 coincide with the leftward direction 56. In a state where the ink cartridge 30 is attached to the cartridge attachment section 110 and capable of being used by the printer 10, an outer surface of the main bottom wall portion 42 of a housing 130 (described later) faces downward, that is, faces in the gravitational direction. Further, at this state, the frontward direction 51 and the rearward direction 52 are perpendicular to the gravitational direction.

Moreover, in the state where the ink cartridge 30 is attached to the cartridge attachment section 110, an outer surface (i.e., front surface) of the front wall 40 faces frontward, an outer surface (i.e., rear surface) of the rear wall 41 faces rearward, an outer surface (i.e., bottom surface) of the bottom wall faces downward, an outer surface (i.e., top surface) of the top wall 39 faces upward.

As illustrated in FIG. 4, the ink cartridge 30 has an overall flattened rectangular parallelepiped shape with a left-right dimension of the ink cartridge 30 (width) is smaller than vertical and front-rear dimensions of the ink cartridge 30 (height and depth).

<Housing 130>

As illustrated in FIG. 3, the housing 130 has a generally box-like shape opening upward. That is, the housing 130 has a top end formed with an opening. In the embodiment, the housing 130 is a container formed of resin. The housing 130 defines a first storage chamber 32 and a second storage chamber 33 therein.

The housing 130 includes the front wall 40, the rear wall 41, the right side wall 37, the left side wall 38, the main bottom wall 42, the subordinate bottom wall 48. The rear wall 41 is spaced away from the front wall 40 in the front-rear direction. The left side wall 38 faces the right side wall 37 in the left-right direction. A gap distance between the front wall 40 and the rear wall 41 is greater than a gap distance between the right side wall 37 and the left side wall 38. The front wall 40, rear wall 41, the right side wall 37, the left side wall 38, the main bottom wall 42 and the subordinate bottom wall 48 define the first storage chamber 32.

In the operational posture of the ink cartridge 30, the front surface of the front wall 40 is a surface of the housing 130 facing frontward, while the rear surface of the rear wall 41 is a surface of the housing 130 facing rearward. The right side wall 37 and the left side wall 38 respectively extend in a direction that crosses the front wall 40 and the rear wall 41. The right side wall 37 connects the front wall 40 to the rear wall 41, the main bottom wall 42, and the subordinate bottom wall 48. Likewise, the left side wall 38 connects the front wall 40 to the rear wall 41, the main bottom wall 42, and the subordinate bottom wall 48. In the operational posture of the ink cartridge 30, the outer surface of the right side wall 37 faces rightward, while the outer surface of the left side wall 38 faces leftward.

As illustrated in FIG. 3, the main bottom wall 42 is inclined relative to the front-rear direction. Specifically, the main bottom wall 42 is inclined so that a rear end thereof is positioned further upward than a front end thereof. The front end of the main bottom wall 42 is positioned frontward relative to the lock surface 151 (described later). The rear end of the main bottom wall 42 is connected to the lower end of the rear wall 41. That is, the main bottom wall 42 extends frontward from the lower end of the rear wall 41. The subordinate bottom wall 48 is positioned upward and frontward relative to the main bottom wall 42.

As illustrated in FIG. 3, the ink cartridge 30 further includes a first inner lid 131, a second inner lid 132, and an outer lid 134. The first inner lid 131 is adapted to close the opening in the top end of the housing 130. Specifically, in the embodiment, the opening in the top end of the housing 130 is closed by the first inner lid 131 and the second inner lid 132. A space defined between the first inner lid 131 and the second inner lid 132 is an air communicating passage 72 for providing communication of the first storage chamber 32 with an ambient air. The first inner lid 131 has a bottom surface defining a ceiling of the first storage chamber 32. The first inner lid 131 is formed with a through-hole 146. The first storage chamber 32 is in communication with the space between the first inner lid 131 and the second inner lid 132 (i.e., the air communicating passage 72) through the through-hole 146. Incidentally, the through-hole 146 is configured to be opened and closed by a valve mechanism.

As illustrated in FIG. 3, the outer lid 134 has a generally box-like shape opening downward. The outer lid 134 covers the housing 130 from above so as to cover the first inner lid 131. As illustrated in FIG. 4, the outer lid 134 includes a protrusion 43 that protrudes upward from the top wall 39. The lock shaft 145 of the cartridge attachment section 110 can access the protrusion 43 from outward thereof.

As illustrated in FIG. 3, the protrusion 43 has a rear end whose rear surface faces rearward. The rear surface of the rear end serves as the lock surface 151. The lock surface 151 is positioned upward relative to the top surface of the top wall 39. The lock surface 151 extends in the up-down direction. The lock surface 151 is configured to contact the lock shaft 145 from frontward thereof in the state where the ink cartridge 30 is attached to the cartridge attachment section 110. Contact of the lock surface 151 with the lock shaft 145 allows the ink cartridge 30 to be retained at the attached position in the cartridge attachment section 110 against the urging force of the coil spring 78.

<Internal Structure of Ink Cartridge 30>

As illustrated in FIG. 3, the ink cartridge 30 includes the first storage chamber 32, the second storage chamber 33, an ink valve chamber 35, and the air communication passage 72.

The ink cartridge 30 includes an inner bottom wall 45. The inner bottom wall 45 extends in the front-rear direction and the left-right direction. The inner bottom wall 45 opposes the first inner lid 131 in the up-down direction. The inner bottom wall 45 partitions the interior space of the housing 130 into the first storage chamber 32 and the second storage chamber 33.

The second storage chamber 33 is adapted to store ink therein. The second storage chamber 33 is housing 130 positioned downward relative to the first storage chamber 32 when the ink cartridge 30 is in the operational posture. The second storage chamber 33 has a volume smaller than a volume of the first storage chamber 32. Thus, a smaller amount of ink can be stored in the second storage chamber 33 than in the first storage chamber 32.

The second storage chamber 33 is in communication with the first storage chamber 32 through a communication hole 47 formed in the inner bottom wall 45. The communication hole 47 is formed in a rear-right end portion of the inner bottom wall 45. The second storage chamber 33 is also in communication with the ink valve chamber 35 through a through-hole 99 formed in a partitioning wall 50.

<Air Communication Passage 72>

As described above, as illustrated in FIG. 3, the air communication passage 72 is the space that provides communication between the first storage chamber 32 and ambient air. Specifically, the air communication passage 72 is the space defined between the first inner lid 131 and the second inner lid 132. The air communication passage 72 is in communication with an exterior of the ink cartridge 30 through a through-hole formed in the first inner lid 131 and a through-hole formed in the outer lid 134. The air communication passage 72 is configured to be opened and closed by a valve mechanism in the embodiment. However, a detailed description of a structure of the valve mechanism is omitted here for simplifying description.

<Ink Supply Portion 34>

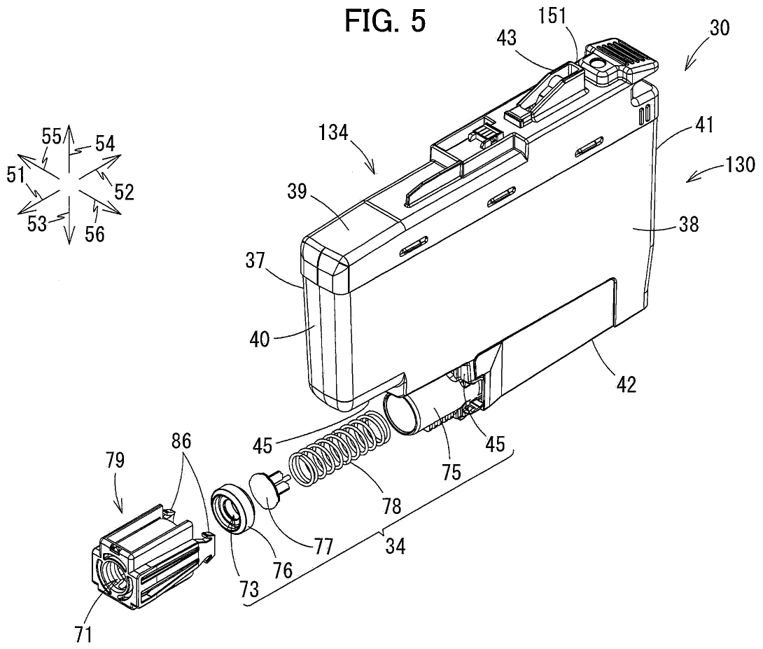

As illustrated in FIGS. 3 and 4, the ink supply portion 34 extends frontward from the connecting wall 49. As illustrated in FIGS. 3 and 5, the ink supply portion 34 includes a cylinder 75, a sealing member 76, a valve 77, the coil spring 78, and a cap 79.

The cylinder 75 extends in the frontward direction 51 from the connecting wall 49. That is, an extending direction of the cylinder 75 is coincident with the frontward direction 51. The cylinder 75 has an outer shape that is generally tubular or hollow cylindrical. The shape of the cylinder 75 is not limited to a circular cylindrical shape. The cylinder 75 may have any shape as long as the cylinder 75 is hollow. The cylinder 75 has a front end that is directed frontward formed with an opening. The front end of the cylinder 75 is positioned downward and rearward of the front wall 40. The cylinder 75 defines an internal space serving as the ink valve chamber 35.

The sealing member 76 has a substantially annular shape as viewed in the front-rear direction. The sealing member 76 is made of an elastic material such as rubber or elastomer. The sealing member 76 is disposed at the front end of the cylinder 75 so as to cover the opening formed in the front end of the cylinder 75. The sealing member 76 has an inner peripheral surface having a circular shape in front view. The inner peripheral surface of the sealing member 76 defines the through-hole 73. The through-hole 73 has an inner diameter slightly smaller than an outer diameter of the ink needle 102 of the cartridge attachment section 110. A detailed configuration of the sealing member 76 will be described later.

The valve 77 and the coil spring 78 are accommodated in the ink valve chamber 35. The valve 77 can contact and separate from the sealing member 76 by moving in the front-rear direction. The valve 77 is configured to open and close the through-hole 73 formed in the center region of the sealing member 76 by contacting and separating from the sealing member 76. The coil spring 78 urges the valve 77 frontward. Accordingly, the valve 77 closes the through-hole 73 of the sealing member 76 while no external force is applied to the valve 77.

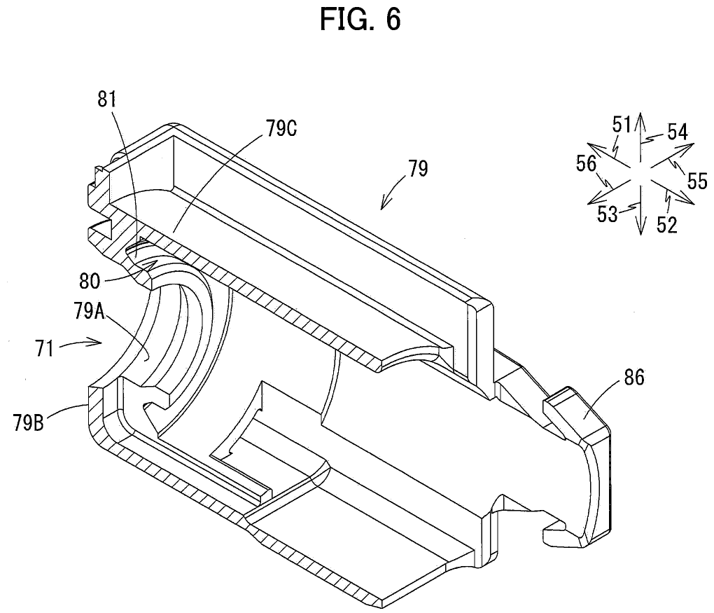

As illustrated in FIGS. 5 and 6, the cap 79 has an outer shape that is generally rectangular parallelepiped. The cap 79 has a hollow configuration. Incidentally, the cap 79 may have an outer shape other than a rectangular parallelepiped, provided that the cap 79 is a hollow member whose front end and rear end are open.

As illustrated in FIG. 6, the cap 79 includes an inner peripheral wall 79A, a front end wall 79B, and an outer peripheral wall 79C. The inner peripheral wall 79A has a substantially annular shape and extends from the front end wall 79B in the rearward direction 52. The inner peripheral wall 79A has an inner peripheral surface defining an ink supply port 71. The ink supply port 71 is open on a front surface of the front end wall 79B and extends in the front-rear direction. The outer peripheral wall 79C has a substantially circular cylindrical shape and is located radially outward of the inner peripheral wall 79A. The outer peripheral wall 79C extends from the front end wall 79B in the rearward direction 52. The inner peripheral wall 79A and the outer peripheral wall 79C are separated by a space (define a gap therebetween, and the gap serves as a space that is open in the rearward direction 52). The space is defined to open in the rearward direction 52. The inner peripheral wall 79A has an outer peripheral surface 81 serving as an engaging surface configured to engage the sealing member 76. The inner peripheral wall 79A protrudes from the front end wall 79B in the rearward direction 52, so that a recess 80 is defined by a rear surface of the front end wall 79B, the outer peripheral surface 81 of the inner peripheral wall 79A, and an inner peripheral surface of the outer peripheral wall 79C. In other words, the recess 80 defines the space.

As illustrated in FIG. 3, in a state where the cap 79 is assembled to the cylinder 75 to cover the cylinder 75 and the sealing member 76, the ink valve chamber 35 is in communication with an outside of the housing 130 through the through-hole 73 of the sealing member 76 and the ink supply port 71 of the cap 79.

As illustrated in FIG. 5, the cap 79 includes a snap-fit 86 configured to engage the housing 130 or the cylinder 75 for assembly thereto. As illustrated in FIG. 3, in the state where the cap 79 covers the cylinder 75 and the sealing member 76 from a front side thereof, the sealing member 76 is fixed between the cap 79 and the cylinder 75, while being interposed therebetween. A liquid-tight seal is thus formed between the sealing member 76 and the cylinder 75, and between the sealing member 76 and the cap 79.

<Sealing Member 76>

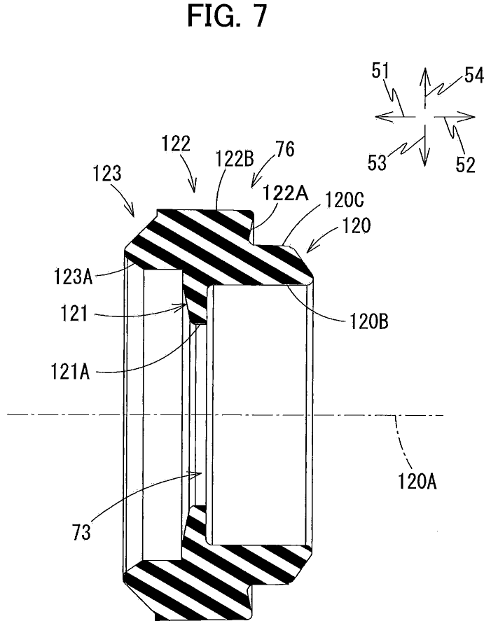

As illustrated in FIG. 7, the sealing member 76 includes a cylindrical portion 120, a first protrusion 121, a second protrusion 122, and a third protrusion 123. The cylindrical portion 120 has a generally circular annular shape. The cylindrical portion 120 has an axis 120A extending in the front-rear direction through a center thereof. The through-hole 73 formed in the sealing member 76 extends in the front-rear direction (i.e., along the axis 120A). The cylindrical portion 120 has an inner peripheral surface 120B and an outer peripheral surface 120C.

The first protrusion 121 extends radially inward from the inner peripheral surface 120B of the cylindrical portion 120. That is, the first protrusion 121 protrudes toward the axis 120A. The first protrusion 121 has a substantially annular shape as viewed along the axis 120A. The first protrusion 121 has a protruding end defining a first sealing surface 121A configured to contact the outer peripheral surface of the ink needle 102. As the ink needle 102 is inserted into the through-hole 73, a portion of the first protrusion 121 near the first sealing surface 121A is caused to elastically deform in a direction along the axis 120A while being in contact with the outer peripheral surface of the ink needle 102. Hence, the first protrusion 121 and the outer peripheral surface of the ink needle 102 are liquid-tightly sealed.

The second protrusion 122 extends radially outward from the outer peripheral surface 120C of the cylindrical portion 120. That is, the second protrusion 122 protrudes in a direction away from the axis 120A. The second protrusion 122 is integrally formed with a front portion of the outer peripheral surface 120C of the cylindrical portion 120. The second protrusion 122 has a second sealing surface 122A extending outward from the outer peripheral surface 120C of the cylindrical portion 120 in a radial direction of the cylindrical portion 120. The second sealing surface 122A connects the outer peripheral surface 120C of the cylindrical portion 120 to an outer peripheral surface 122B of the second protrusion 122.

The second sealing surface 122A has a substantially circular annular shape as viewed in the front-rear direction (along the axis 120A). The second sealing surface 122A is inclined toward the axis 120A. In other words, the second sealing surface 122A is inclined relative to the radial direction of the cylindrical portion 120. Specifically, the second sealing surface 122A extends away from the axis 120A toward the rear. That is, an outer end of the second sealing surface 122A is positioned further rearward relative to an inner end of the second sealing surface 122A. The second sealing surface 122A adapted to contact a distal end (front end) of the cylinder 75 to provide a liquid-tightly seal between the cylinder 75 and the sealing member 76.

The third protrusion 123 protrudes from the cylindrical portion 120 in the frontward direction 51. The third protrusion 123 is integrally formed with the front portion of the cylindrical portion 120 and a front portion of the second protrusion 122. The third protrusion 123 has a tapered shape that tapers toward the front in the frontward direction 51. That is, the third protrusion 123 has the tapered shape whose radial dimension gradually decreases toward the front in the frontward direction 51. The third protrusion 123 has a contacting surface 123A that is inclined relative to the axis 120A to extend rearward toward the axis 120A. The contacting surface 123A is accommodated in the recess formed between the inner peripheral wall 79A and the outer peripheral wall 79C of the cap 79. The contacting surface 123A accommodated in the recess is in contact with (i.e., in engagement with) the outer peripheral surface 81 of the cap 79. The contacting surface 123A extends in a circumferential direction of the cylindrical portion 120 to form an annular shape. Therefore, the contacting surface 123A adapted to contact the outer peripheral surface 81 of the cap 79 over an entirety thereof in the circumferential direction of the cylindrical portion 120.

As illustrated in FIGS. 8 and 9, as the ink cartridge 30 is inserted into the cartridge attachment section 110, the ink needle 102 of the cartridge attachment section 110 enters into the ink valve chamber 35 through the ink supply port 71 and the through-hole 73. At this time, the outer peripheral surface of the ink needle 102 is in liquid-tight contact with the first sealing surface 121A of the first protrusion 121 while elastically deforming the first protrusion 121 of the sealing member 76 rearward.

As indicated by arrows in FIG. 9, as the ink needle 102 elastically deforms the first protrusion 121 of the sealing member 76 in the rearward direction 52, the third protrusion 123 of the sealing member 76 is caused to move rearward together with the first protrusion 121. As a result, the third protrusion 123 is caused to deform so as to fall toward the axis 120A. However, since the contacting surface 123A of the third protrusion 123 is in contact with the outer peripheral surface 81 of the cap 79, the third protrusion 123 does not bent (move) toward the axis 120A.

As the ink cartridge 30 is further inserted into the cartridge attachment section 110, the valve 114 protruding rearward through the opening 116 of the ink needle 102 contacts the valve 77. Here, in the embodiment, an urging force of the coil spring 78 that urges the valve 77 in the frontward direction 51 is stronger than an urging force of the coil spring 115 that urges the valve 114 in the rearward direction 52. Therefore, the valve 77 moves the valve 114 forward, that is, to the open position, against the urging force of the coil spring 115.

When the valve 114 moves to the open position, the distal end of the ink needle 102 contacts the valve 77. As the ink cartridge 30 is further inserted into the cartridge attachment section 110, the ink needle 102 moves the valve 77 in the rearward direction 52, that is, to the open position, against the urging force of the coil spring 78.

In this way, as illustrated in FIG. 9, the ink supply port 71 and the opening 116 are both opened. The ink is allowed to circulate between an inner space of the ink valve chamber 35 of the ink supply portion 34 and the internal space in the ink needle 102.

### Advantageous Effects (Technical Advantages) of the Embodiment

According to the above-described embodiment, during attachment of the ink cartridge 30 to the cartridge attachment section 110, as the ink needle 102 elastically deforms the first protrusion 121, the third protrusion 123 of the sealing member 76 tends to move rearward together with the first protrusion 121. However, since the contacting surface 123A of the third protrusion 123 is in contact with the outer peripheral surface 81 of the cap 79, the third protrusion 123 does not move toward the axis 120A. This contact between the contacting surface 123A and the outer peripheral surface 81 can restrict the sealing member 76 from coming off the cap 79.

According to the structure of the above-described embodiment, the second sealing surface 122A of the sealing member 76 is inclined relative to the axis 120A. Therefore, in a state where the cylinder 75 and the sealing member 76 are assembled to each other, the second sealing surface 122A is less likely to be removed from the distal end of the cylinder 75 than otherwise. That is, an outer end of the second sealing surface 122A is less likely to be taken off the distal end of the cylinder 75. Displacement of the sealing member 76 relative to the cylinder 75 is less likely to occur.

According to the structure of the above-described embodiment, the third protrusion 123 of the sealing member 76 has the tapered shape that tapers toward the front in the frontward direction 51 along the axis 120A. This tapered shape of the third protrusion 123 facilitates insertion of the sealing member 76 into the space defined by the recess 80 of the cap 79, and assembly of the sealing member 76 to the cap 79.

According to the structure of the above-described embodiment, the ink cartridge 30 includes the valve 77 that is configured to close the through-hole 73 in a state where the valve 77 is in contact with the sealing member 76. Therefore, when the ink cartridge 30 is not attached to the cartridge attachment section 110, the ink does not flow out of the first storage chamber 32 through the through-hole 73.

### Variations and Modifications

In the above-described embodiment, the valve 77 is provided in the internal space of the ink needle 102. However, the valve 77 need not be provided in the internal space of the ink needle 102. For example, the opening 116 of the ink needle 102 may always be open.

In the above-described embodiment, contact between the lock shaft 145 and the lock surface 151 holds the ink cartridge 30 in the attached position. However, the ink cartridge 30 may not be held in the attached position by the contact between the lock shaft 145 and the lock surface 151. Any other known configuration may be employed to hold the ink cartridge 30 in the attached position.

In the above-described embodiment, communication between the interior and the exterior of the ink supply portion 34 is interrupted and allowed by the valve 77. However, the opening in the front end of the cylinder 75 may be coved by a seal member formed of elastic resin and having no through-hole. The seal member may be opened by piercing with a needle or the like, and may be closed by the elasticity of the seal member as the needle is removed from the seal member.

In the above-described embodiment, the ink cartridge 30 has the outer shape as illustrated in FIGS. 4 and 5. Further, in the above-described embodiment, the ink supply portion 34 extends frontward from the connecting wall 49 and is positioned downward and rearward of the front wall 40. However, the ink cartridge 30 need not be so shaped and the ink supply portion 34 need not be so positioned as illustrated in FIG. 4.

For example, the distance between the right side wall 37 and the left side wall 38 may be greater than the distance between the front wall 40 and the rear wall 41. Alternatively, the ink cartridge 30 may have a simple rectangular shape in a side view. Still further, the ink supply portion 34 may extends frontward from the front wall 40. Alternatively, the ink supply portion 34 may extend downward from the main bottom wall 42.

In the above-described embodiment, ink is exemplified as liquid. However, in place of ink, a pretreatment liquid that is ejected onto the recording paper prior to ink during a printing operation may be stored in a liquid cartridge as the liquid. Alternatively, water that is used for cleaning the recording head 21 may be stored in a liquid cartridge. In other words, the ink cartridge 30 described herein need not be a cartridge for storing ink, but may be a cartridge for a storing any liquid that the printer 10 consumes.

### Remarks

The ink cartridge 30 is an example of a liquid cartridge. The ink is an example of a liquid. The first storage chamber 32 is an example of a storage chamber. The cylinder 75 is an example of a liquid supply tube. The through-hole 73 is an example of a liquid supply hole. The ink supply port 71 is an example of an opening. The ink supplying device 100 is an example of a liquid supplying device. The ink needle 102 is an example of a liquid supply needle. The valve 114 is an example of a needle valve.

What is claimed is:

1. A liquid cartridge detachably attachable to an attachment section including a liquid supply needle, the liquid cartridge comprising:
a housing having a liquid storage chamber configured to store liquid therein;
a liquid supply tube defining an internal space therein and extending in an extending direction from the housing and having a distal end formed with an opening, the liquid supply tube being configured to provide communication between the liquid storage chamber and the liquid supply needle;
a sealing member sealing the opening of the liquid supply tube and having a liquid supply hole extending in the extending direction; and
a cap having an opening through which the liquid supply needle is inserted, the sealing member being interposed between the cap and the liquid supply tube in the extending direction,
wherein the sealing member is elastically deformable, the sealing member comprising:
a cylindrical portion defining an axis extending in the extending direction;
a first protrusion protruding radially inward from an inner peripheral surface of the cylindrical portion, the first protrusion having a first protruding end defining a first sealing surface facing the axis, the first sealing surface being configured to contact an outer peripheral surface of the liquid supply needle;
a second protrusion protruding radially outward from an outer peripheral surface of the cylindrical portion to have a second protruding end in a direction away from the axis, the second protruding end having a second sealing surface in contact with the distal end of the liquid supply tube; and
a third protrusion protruding from the cylindrical portion in the extending direction along the axis to have a third protruding end in the extending direction, the third protrusion having a contacting surface inclined relative to the axis to face the axis, the contacting surface being in contact with the cap.

2. The liquid cartridge according to claim 1, wherein the second sealing surface extending radially inward from an outer peripheral surface of the second protruding end toward the axis, the second sealing surface being inclined relative to the axis to face the axis.

3. The liquid cartridge according to claim 1, wherein the third protrusion has a tapered shape that tapers toward the third protruding end.

4. The liquid cartridge according to claim 1, further comprising a valve configured to contact and separate from the sealing member in the internal space of the liquid supply tube, the valve being configured to close the liquid supply hole in a state where the valve is in contact with the sealing member.

5. The liquid cartridge according to claim 1, wherein the cap comprises a recess in which the third protrusion is received, and wherein the recess has an engaging surface in engagement with the contacting surface of the sealing member.

6. The liquid cartridge according to claim 1, wherein the cap comprises:
a first cylinder extending in the extending direction and defining a hollow space therein for receiving the liquid supply tube, the first cylinder having a first end in the extending direction; and
a second cylinder extending in the extending direction and located radially inward of the first cylinder and defining the opening, the first cylinder and the second cylinder defining a gap therebetween, the second cylinder having a second end in the extending direction;
a connecting wall connecting the first end and the second end, the connecting wall having a ring-like shape, the first end, the second end and the connecting wall providing a recess in communication with the gap, the recess receiving the third protrusion.

7. A liquid supplying device comprising:
the liquid cartridge according to claim 4; and
a cartridge attachment section to which the liquid cartridge is detachably attachable, the cartridge attachment section comprising:
a liquid supply needle defining an inner space therein and having a distal end formed with an opening; and
a needle valve positioned in the inner space of the liquid supply needle, the needle valve being configured to open and close the opening of the liquid supply needle,
wherein, in a state where the liquid cartridge is attached to the cartridge attachment section,
the liquid supply needle is inserted in the liquid supply tube through the liquid supply hole and the opening of the cap, and
the needle valve contacts the valve to open the opening of the liquid supply needle to provide communication between the inner space of the liquid supply needle and the liquid storage chamber.

8. A liquid cartridge comprising:
a housing having a liquid storage chamber configured to store liquid therein;
a liquid supply tube defining an internal space therein and extending in an extending direction from the housing and having a distal end formed with an opening;
a sealing member sealing the opening of the liquid supply tube and having a liquid supply hole extending in the extending direction; and
a cap having an opening, the sealing member being interposed between the cap and the liquid supply tube in the extending direction,
wherein the sealing member is elastically deformable, the sealing member comprising:
a cylindrical portion defining an axis extending in the extending direction,
a first protrusion protruding radially inward from an inner peripheral surface of the cylindrical portion, the first protrusion having a first protruding end defining a first sealing surface facing the axis;
a second protrusion protruding radially outward from an outer peripheral surface of the cylindrical portion to have a second protruding end in a direction away from the axis, the second protruding end having a second sealing surface in contact with the distal end of the liquid supply tube; and
a third protrusion protruding from the cylindrical portion in the extending direction along the axis to have a third protruding end in the extending direction, the third protrusion having a contacting surface inclined relative to the axis to face the axis, the contacting surface being in contact with the cap.

9. The liquid cartridge according to claim 8, wherein the second sealing surface extending radially inward from an outer peripheral surface of the second protruding end toward the axis, the second sealing surface being inclined relative to the axis to face the axis.

10. The liquid cartridge according to claim 8, wherein the third protrusion has a tapered shape that tapers toward the third protruding end.

11. The liquid cartridge according to claim 8, further comprising a valve configured to contact and separate from the sealing member in the internal space of the liquid supply tube, the valve being configured to close the liquid supply hole in a state where the valve is in contact with the sealing member.

12. The liquid cartridge according to claim 8, wherein the cap comprises a recess in which the third protrusion is received, and wherein the recess has an engaging surface in engagement with the contacting surface of the sealing member.

13. The liquid cartridge according to claim 8, wherein the cap comprises:
a first cylinder extending in the extending direction and defining a hollow space therein for receiving the liquid supply tube, the first cylinder having a first end in the extending direction; and
a second cylinder extending in the extending direction and located radially inward of the first cylinder and defining the opening, the first cylinder and the second cylinder defining a gap therebetween, the second cylinder having a second end in the extending direction;
a connecting wall connecting the first end and the second end, the connecting wall having a ring-like shape, the first end, the second end and the connecting wall providing a recess in communication with the gap, the recess receiving the third protrusion.
